(19) United States
(12) Patent Application Publication
(10) Pub. No.: US 2014/0159972 A1
(43) Pub. Date: Jun. 12, 2014

(54) ON-BOARD RADAR HAVING LENS ANTENNA

(71) Applicants: Honda elesys Co., Ltd., Yokohama-shi (JP); NATIONAL UNIVERSITY CORPORATION SHIZUOKA UNIVERSITY, Shizuoka-shi (JP)

(72) Inventors: Yoshihiko KUWAHARA, Hamamatsu-shi (JP); Hiroyuki Kamo, Yokohama-shi (JP)

(73) Assignees: Honda elesys Co., Ltd., Yokohama-shi (JP); NATIONAL UNIVERSITY CORPORATION SHIZUOKA UNIVERSITY, Shizuoka-shi (JP)

(21) Appl. No.: 14/099,356

(22) Filed: Dec. 6, 2013

(30) Foreign Application Priority Data
Dec. 7, 2012 (JP) 2012-268563

(51) Int. Cl. H01Q 19/06

(52) U.S. Cl. CPC H01Q 19/06
USPC 343/753

(57) ABSTRACT

An on-board radar includes a lens antenna which includes a lens, a substrate provided with a hole for disposing the lens, a plurality of parts provided on a portion of the substrate other than a portion on which the lens is provided, and a primary radiator which radiates electromagnetic waves onto the lens.

### CROSS-REFERENCE TO RELATED APPLICATIONS

Priority is claimed on Japanese Patent Application No. 2012-268563, filed Dec. 7, 2012, the contents of which are entirely incorporated herein by reference.

### BACKGROUND OF THE INVENTION

1. Field of the Invention

The present invention relates to an on-board radar having a lens antenna.

2. Description of Related Art

An on-board radar which is mounted on a vehicle such as an automobile is implemented.

An example of the related art is a radar apparatus which is disclosed in Japanese Unexamined Patent Application, First Publication No. 2000-028704, which includes a transmission wave generation means which transmits a transmission wave toward a target; a first reception antenna and a second reception antenna which individually receive a reflected wave which is obtained by causing the transmission wave to be reflected on the target, and which are disposed distanced by a predetermined interval; an angle calculation means which calculates a target angle using the amplitude comparison monopulse method on a basis of reception power of the first reception antenna and the second reception antenna; a first phase difference calculation means which calculates a phase difference between received signals based on the target angle from the angle calculation means; a second phase difference calculation means which directly calculates the phase difference between the received signals of the first reception antenna and the second reception antenna; a phase difference comparison means which compares the phase differences which are calculated by the first phase difference calculation means and the second phase difference calculation means; and a determination means which determines that the target is a real image when a difference value obtained by the phase difference comparison means is less than a predetermined value, and determines that the target is a false image when the difference value is the predetermined value or more. Accordingly, the radar apparatus is designed to distinguish whether or not the detected target is a false image which is generated by side lobes of the antenna reception beam.

In a general on-board radar, electronic parts which configure a power supply, a control system and an RF (Radio Frequency) system are implemented on a surface which opposes a radiating element of an antenna part for transmitting and receiving. A reason for this is that when parts are implemented in the direction of or in the periphery of the radiation surface of the antenna, the radar performance is reduced due to the parts blocking the transmission and reception waves, disturbing the antenna aperture distribution or the like.

However, an on-board radar is known which is provided with a lens antenna including a primary radiator and a lens.

A lens antenna used in an on-board radar has a high radiation efficiency, and multiple beams can be disposed over a wide range. In order to elicit such performance, it is preferable that spillover be reduced as much as possible. The reason for this is that, degrading of the directivity due to a disturbance in the aperture distribution of the lens antenna, the direct wave of the primary radiator causing the side lobe level to rise, and the like occur due to spillover. Various measures are devised in order to suppress spillover, such as adjusting the distance (the focal length of the lens) between the lens and the primary radiator (for example, adjusting while considering the relationship with the aperture efficiency), and narrowing the directivity of the primary radiator (causing the radiation waves to irradiate the lens as much as possible). Furthermore, “spillover” refers to a phenomenon in which a portion of the electromagnetic wave, which is emitted from the primary radiator, is radiated without passing through a lens or a parabolic reflector.

However, it is impossible to completely prevent spillover due to the design of the packaging of the radar, and normally it is necessary to permit performance tradeoffs such as surrounding the periphery of the lens with an electromagnetic wave absorber, reducing the aperture efficiency and reducing the number of beams.

### SUMMARY OF THE INVENTION

In a radar to which the lens antenna method is applied, while the radar has superior performance, when compared to a radar to which a patch array antenna method or a slot array antenna method is applied, the dimension of the depth direction is increased since a vacancy portion (a vacancy portion corresponding to the focal length of the lens) is necessary between the lens portion and the primary radiator unit.

In a radar to which the lens antenna method is applied, when the various parts are implemented on the rear surface (here, the rear surface of the substrate on which the primary radiator is implemented) of the antenna as a similar configuration to that of the related art, the dimension of the depth direction is further increased. In the trends of the radar market in recent years, since there is a tendency for thinning to be in strong demand from a perspective of installation conditions to a vehicle and the external appearance thereof, there is a demand to reduce the depth dimension of the radar as much as possible.

Here, from a viewpoint of the performance of the radar provided with a lens antenna, the problem is realizing a countermeasure for spillover, which is mainly caused by degradation of the directivity, an increase in side lobe level and the like.

As a specific example, in order to realize a general multi-beam radar which can detect a wide range, a lens or a reflector is used which has an elliptical shape and is narrow in the width direction. In this case, spillover increases in relation to the normal radar antenna.

In addition, as a specific example, in order to achieve cost savings and miniaturization, there is a demand for the substrate on which the primary radiator is implemented to be compact. In this case, since the implementation area of the antenna element which is necessary for forming the directivity of the primary radiator is insufficient, spillover increases without being able to sufficiently narrow the directivity.

In addition, as a specific example, there is a case in which a high density multi-beam arrangement (an increase in the number of beams) is necessary as a means for improving the performance of the radar, or for adding functionality. In this case, since the implementation space per element is reduced with the densification of the multi-beam and the implementation area of the antenna element is insufficient, spillover increases without being able to sufficiently narrow the directivity.

Since such problems (the specific examples and the like described above) are conceivable, for example, it is difficult to counter spillover by creative design of the antenna alone.

The present invention was devised in consideration of such problems, and an object is to provide an on-board radar provided with a lens antenna which can reduce the influence of spillover.

According to an aspect of the present invention, there is provided an on-board radar including a lens antenna which includes a lens, a substrate provided with a hole for disposing the lens, a plurality of parts provided on a portion of the substrate other than a portion on which the lens is provided, and a primary radiator which radiates electromagnetic waves onto the lens.

In the on-board radar described above, the plurality of parts may be provided on a portion of the substrate in a periphery of the lens.

In the on-board radar described above, the plurality of parts may be provided on a surface of the substrate which faces the primary radiator.

In the on-board radar described above, a plurality of primary radiators may be provided as the primary radiators which configure the lens antenna.

As described above, according to the various aspects of the present invention, it is possible to provide an on-board radar provided with a lens antenna which can reduce the influence of spillover.

### BRIEF DESCRIPTION OF THE DRAWINGS

FIG. 1 is a rear surface view of the substrate portion which configures the on-board radar provided with the lens antenna according to an embodiment of the present invention.

FIG. 2 is an upper surface view of the substrate portion and the primary radiator unit (which contains three primary radiators) which configure the on-board radar provided with a lens antenna according to an embodiment of the present invention.

FIG. 3 is a view showing an example of the schematic disposition of the primary radiator unit (which contains three primary radiators) and the lens which configure the lens antenna according to an embodiment of the present invention.

FIG. 4 is a view showing an example of the relationship between the orientation angle and the normalized gain in the on-board radar provided with the lens antenna according to an embodiment of the present invention.

FIG. 5 is a view showing an example of the relationship between the orientation angle and the normalized gain in the on-board radar provided with the lens antenna according to an example of the related art.

FIG. 6 is a view showing a configuration example of a primary radiator unit provided with five primary radiators.

FIG. 7 is a schematic rear surface view of the substrate portion which configures the on-board radar provided with the lens antenna of a configuration in which the beam center axis lines of the plurality of primary radiators are disposed non-symmetrically.

FIG. 8 is a schematic upper surface view of the substrate portion and the primary radiator unit (which contains three primary radiators) which configure the on-board radar provided with the lens antenna of a configuration in which the beam center axis lines of the plurality of primary radiators are disposed non-symmetrically.

FIG. 9 is a schematic rear surface view of the substrate portion which configures the on-board radar provided with the lens antenna of a configuration in which the beam widths of the plurality of primary radiators are different from one another.

FIG. 10 is a schematic upper surface view of the substrate portion and the primary radiator unit (which contains three primary radiators) which configure the on-board radar provided with the lens antenna of a configuration in which the beam widths of the plurality of primary radiators are different from one another.

### DETAILED DESCRIPTION OF THE INVENTION

Description of Configuration of on-Board Radar Having Lens Antenna According to Present Embodiment

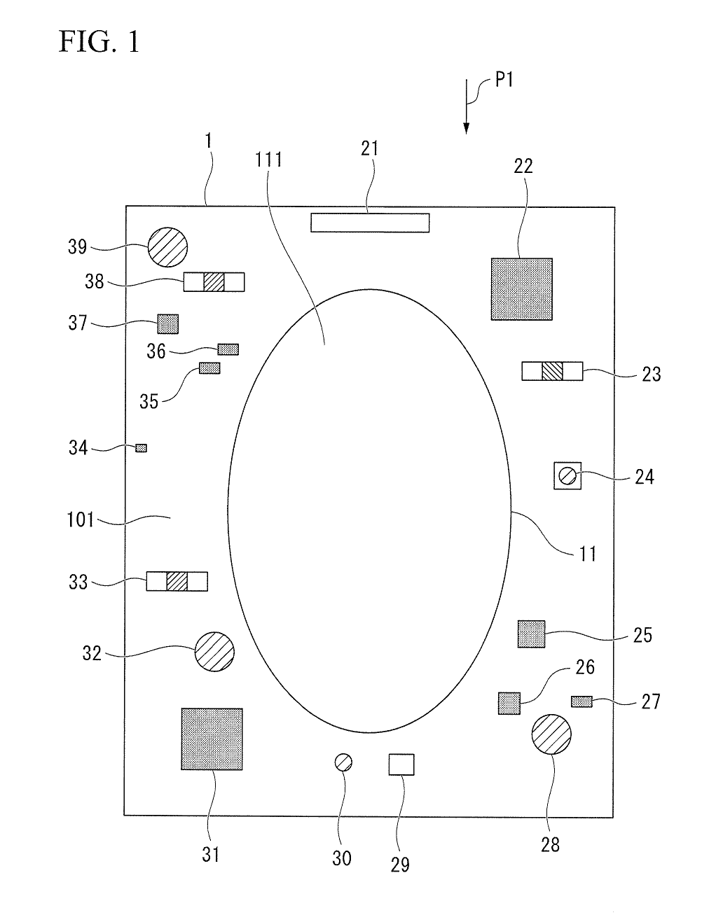

FIG. 1 is a rear surface view (a view when seen from the disposition region of primary radiators 51 to 53) of the substrate portion which configures the on-board radar provided with the lens antenna according to the present embodiment.

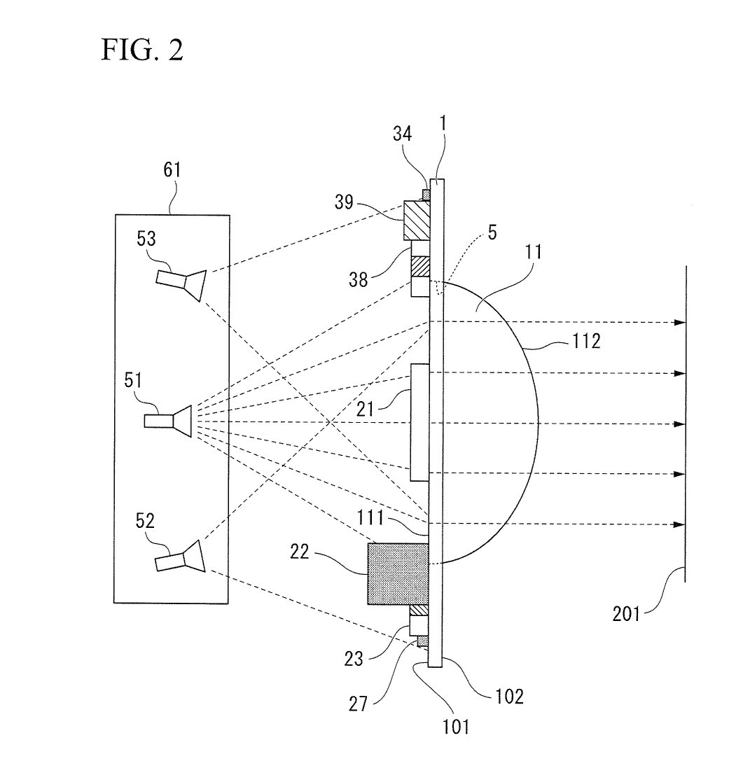

FIG. 2 is an upper surface view (a view when seen from the orientation of an arrow P1 shown in FIG. 1) of the substrate portion and a primary radiator unit 61 (which contains the three primary radiators 51 to 53) which configure the on-board radar provided with a lens antenna according to the present embodiment.

The on-board radar provided with the lens antenna according to the present embodiment includes a substrate portion, the primary radiator unit 61 (not shown in FIG. 1), and other parts (not shown) such as a cover (a housing).

The lens antenna according to the present embodiment includes the primary radiator unit 61 which has three of the primary radiators 51 to 53, and a lens 11.

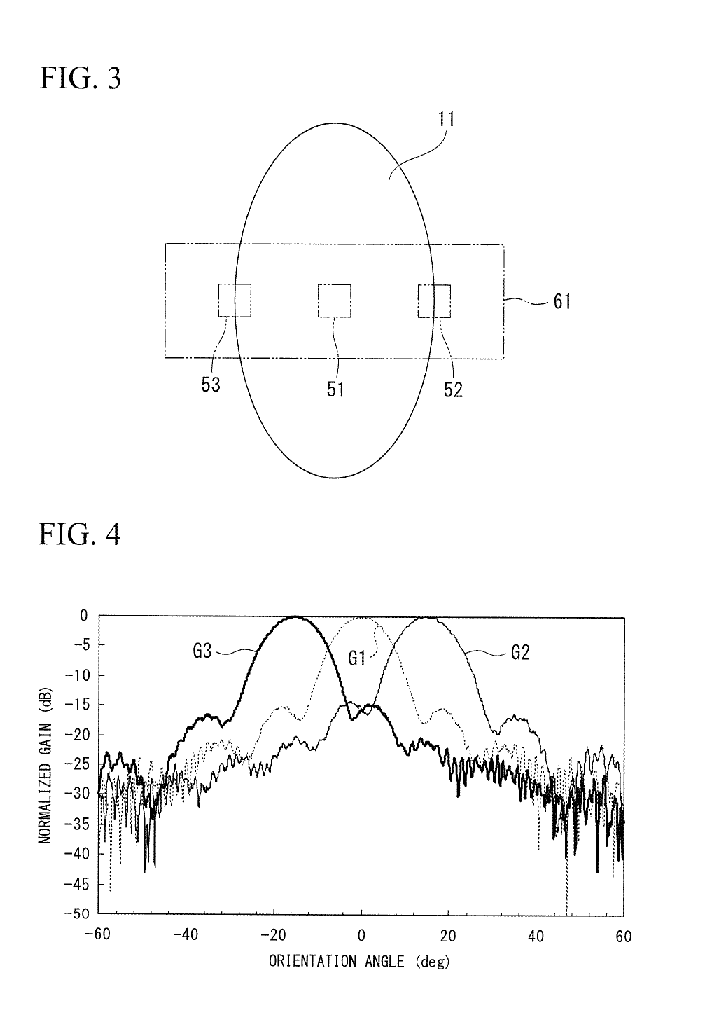

FIG. 3 is a view showing an example of the schematic disposition of the primary radiator unit 61 (which contains the three primary radiators 51 to 53 in the present embodiment) and the lens 11 which configure the lens antenna according to the present embodiment.

Furthermore, in the present embodiment, a combination of a plurality of (three in the present embodiment) the primary radiators 51 to 53 is referred to as the primary radiator unit 61. However, in reality, the primary radiator unit 61 may be realized as, for example, a substrate provided with the plurality of (three in the present embodiment) the primary radiators 51 to 53, or, not exist as an entity and each of the plurality of (three in the present embodiment) the primary radiators 51 to 53 may also be provided separately.

Description will be given of the configuration of the on-board radar provided with the lens antenna according to the present embodiment.

The substrate portion which configures the on-board radar provided with the lens antenna according to the present embodiment includes a substrate 1, the lens 11, and a plurality of parts 21 to 39.

The substrate 1 is an electronic circuit board (for example, a general printed circuit board) and the shape of the surface thereof is rectangular. In addition, the substrate 1 is a single-sided circuit board. In addition, of the two surfaces which the substrate 1 has, a first surface 101 (a part implementation surface) which implements the parts is disposed so as to face the primary radiators 51 to 53, and a second surface 102 (the grounding surface) which is the other surface is disposed on the opposite side. In addition, the first surface 101 and the second surface 102 of the substrate 1 are parallel, and are disposed so as to be perpendicular in relation to the proceeding direction of the light which is emitted from the center axis of the primary radiator 51 of the center. In addition, the three primary radiators 51 to 53 and the substrate 1 are disposed such that the direction in which the three primary radiators 51 to 53 are arranged and the extending direction of the short sides of the rectangle which defines the substrate 1 substantially match (as another configuration example, when the three primary radiators 51 to 53 are arranged in a straight line, the direction in which the primary radiators 51 to 53 are arranged and the extending direction of the short sides of the rectangle which defines the substrate 1 match).

In addition, a hole (a hole which penetrates the substrate 1) 5 for fitting and disposing the lens 11 is provided in the substrate 1. The lens 11 is fitted into the hole 5 and the lens 11 is fixed to the substrate 1. Furthermore, an arbitrary method can be used as the fixing method, for example, it is possible to use a fitting method in which the lens 11 is fixed to the substrate 1 only by fitting the lens 11 into the hole 5, it is also possible to use a method in which the lens 11 is fixed to the substrate 1 by fastening the lens 11 to the substrate 1 using screws or the like, and it is also possible to use a method in which the lens 11 is fixed to the substrate 1 using an adhesive.

The lens 11 is a flat-convex lens in which a first surface 111 is a flat surface and a second surface 112 is a convex surface (a convex spherical surface). The first surface 111 of the lens 11 is disposed in a disposition region of the first surface 101 of the substrate 1, and the second surface 112 of the lens 11 is disposed in a disposition region of the second surface 102 of the substrate 1.

Here, the first surface 111 of the lens 11 is disposed so as to be positioned on the same surface as the first surface 101 of the substrate 1, and the second surface 112 of the lens 11 is disposed so as to protrude from the second surface 102 of the substrate 1.

In addition, the first surface 111 of the lens 11 has an elliptical shape. Furthermore, the first surface 111 of the lens 11 and the substrate 1 are disposed such that the long axis direction of the elliptical shape of the first surface 111 of the lens 11 and the extending direction of the long side of the rectangle which defines the substrate 1 match. In addition, the first surface 111 of the lens 11 and the substrate 1 are disposed such that the short axis direction of the elliptical shape of the first surface 111 of the lens 11 and the extending direction of the short side of the rectangle which defines the substrate 1 match.

In addition, as the lens 11, a lens (a focus lens with three focal points) is used which has three focal points, the same number as the corresponding three primary radiators 51 to 53.

In this manner, in the present embodiment, as shown in FIG. 3, a plurality of (three in the present embodiment) the primary radiators 51 to 53 are arranged in the short axis direction (or a similar direction thereto) of the ellipse of the first surface 111 of the lens 11.

Each of the parts 21 to 39 is implemented on the first surface 101 of the substrate 1 and is disposed in the periphery of the first surface 111 of the lens 11 so as to surround the radiation aperture portion of the lens antenna.

Each of the parts 21 to 39 configures the on-board radar according to the present embodiment, for example, an electronic part (for example, an active part, a passive part or a mechanical part), however, other parts (parts which are not electronic parts) may also be included.

Specific examples of the parts which can be used include a connector (for example, part 21) which supplies a power supply to the primary radiators 51 to 53, an IC (Integrated Circuit) chip such as a transistor (for example, parts 22 and 25), a resistor or a chip condenser (for example, parts 23 and 33), and an electrolytic condenser (for example, part 24) which configures a volume. Furthermore, the parts described above are examples, and arbitrary parts which configure the on-board radar according to the present embodiment can be used as each of the parts 21 to 39.

The primary radiator unit 61 which configures the on-board radar provided with the lens antenna according to the present embodiment includes three of the primary radiators 51 to 53 (the first primary radiator 51, the second primary radiator 52 and the third primary radiator 53).

The three primary radiators 51 to 53 are arranged at an equal interval (or a substantially equal interval) such that the primary radiators 52 and 53 are also positioned on an arc (or a shape such as a polygonal shape close to an arc) which passes through the position of the primary radiator 51. Furthermore, the basis points of the primary radiators 51 to 53 which are referred to when determining the disposition of the primary radiators 51 to 53 can be one arbitrary point in the primary radiators 51 to 53. In addition, when radiators of the same shape are used as the primary radiators 51 to 53, the point can be used as the basis point of the same-point primary radiators 51 to 53 which have the same shape.

In addition, a center axis of the radiation direction of the light of the first primary radiator 51 and the optical axis of the lens 11 are disposed so as to match. In addition, the primary radiator unit 61 (the three primary radiators 51 to 53) is disposed separated from the substrate portion, is implemented using an arbitrary configuration (for example, a configuration which uses another substrate) and the position thereof is fixed.

Each of the primary radiators 51 to 53 is configured using a patch antenna, for example.

The light radiated from each of the primary radiators 51 to 53 strikes the first surface 111 of the lens 11 and the periphery thereof. The light which strikes the first surface 111 of the lens 11 is radiated from the second surface 112 of the lens 11 as a planar wave 201 with a matched phase.

Specific Example of Effects of on-Board Radar Having Lens Antenna According to Present Embodiment

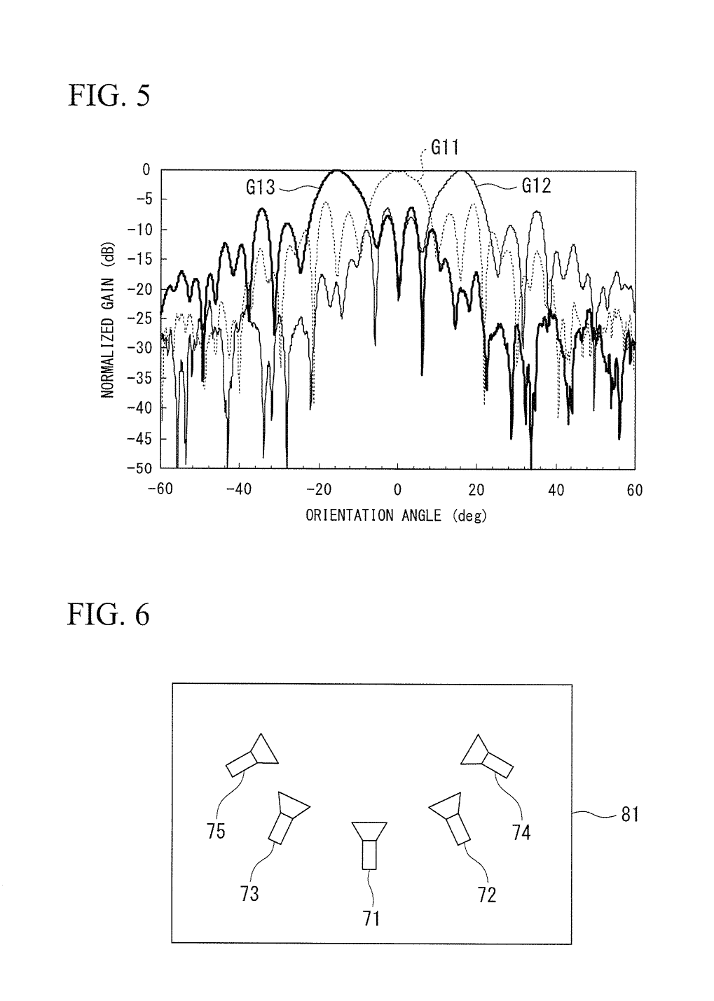

A specific example will be given of the effects which can be obtained according to the on-board radar provided with the lens antenna according to the present embodiment with reference to FIGS. 4 and 5.

FIG. 4 is a view showing an example (an example of the measurement results) of the relationship between the orientation angle (deg) and the normalized gain (dB) in the on-board radar provided with the lens antenna according to the present embodiment.

FIG. 5 is a view showing an example (an example of the measurement results) of the relationship between the orientation angle (deg) and the normalized gain (dB) in the on-board radar provided with the lens antenna according to an example of the related art.

Here, the on-board radar provided with the lens antenna according to the present embodiment related to FIG. 4 includes the configuration which is described with reference to FIGS. 1 to 3.

In addition, the on-board radar provided with the lens antenna according to the example of the related art related to FIG. 5 has a configuration in which the on-board radar is provided with three primary radiators (which correspond to the three primary radiators 51 to 53) which are disposed in the same manner as the case of the on-board radar provided with the lens antenna according to the present embodiment. However, the lens (which corresponds to the lens 11) and the substrate (which corresponds to the substrate 1) are provided separately, the three primary radiators and the plurality of parts (for example, the electronic parts) are implemented on the substrate, and the lens described above is individually disposed further forward than the substrate (the direction in which the light of the radar is radiated).

In the graphs shown in FIGS. 4 and 5, the horizontal axis represents the orientation angle (deg) and the vertical axis represents the normalized gain (dB).

Here, the orientation angle (deg) is an angle based on the lens (the lens 11 in the present embodiment, and the corresponding part in the example of the related art) when the front surface of the lens (the optical axis direction) is set to 0° and is the angle on the plane on which the three primary radiators (the three primary radiators 51 to 53 in the present embodiment and the corresponding part in the related art) are present.

In the graph shown in FIG. 4, the properties which correspond to the light (the first beam) radiated from the first primary radiator 51 according to the present embodiment are represented by a first property G1, the properties which correspond to the light (the second beam) radiated from the second primary radiator 52 according to the present embodiment are represented by a second property G2, and the properties which correspond to the light (the third beam) radiated from the third primary radiator 53 according to the present embodiment are represented by a third property G3.

In the graph shown in FIG. 5, the properties which correspond to the light (the first beam) radiated from the first primary radiator according to an example of the related art (corresponding to the first primary radiator 51 according to the present embodiment) are represented by a first property G11, the properties which correspond to the light (the second beam) radiated from the second primary radiator according to an example of the related art (corresponding to the second primary radiator 52 according to the present embodiment) are represented by a second property G12, and the properties which correspond to the light (the third beam) radiated from the third primary radiator according to an example of the related art (corresponding to the third primary radiator 53 according to the present embodiment) are represented by a third property G13.

As shown in FIG. 4, in the properties G1 to G3 according to the present embodiment, the influence of spillover is small (ideally, there is no influence of spillover), and warping near the peaks and the like of each beam is little. The reason for this is mainly that, in the on-board radar provided with the lens antenna according to the present embodiment, a portion of the substrate 1 present in the periphery of the lens 11 blocks spillover light in the substrate portion.

On the other hand, as shown in FIG. 5, in the properties G11 to G13 according to the example of the related art, the influence of spillover is great, and since the aperture distribution is disturbed, the warping near the peaks and the like of each beam is great.

### Summary of Present Embodiment

As described above, in the on-board radar provided with the lens antenna according to the present embodiment, the substrate 1 on which each of the parts 21 to 39 is implemented is installed so as to surround the radiation aperture portion (the periphery of the lens 11) of the lens antenna. In the same manner as an ordinary electronic circuit board, the substrate 1 according to the present embodiment is configured to include the first surface 101 and the second surface 102, and the substrate 1 can be perceived as a conductive plate, which has unevenness (for example, random unevenness) due to the parts 21 to 39, which surrounds the periphery of the lens 11.

Therefore, according to the on-board radar provided with the lens antenna according to the present embodiment, it is possible to obtain a blocking effect of spillover of the aperture portion of the lens 11 due to the portion of the substrate 1 which is present in the periphery of the lens 11. Accordingly, it is possible to reduce (ideally, set to zero) the influence of spillover.

For example, in the on-board radar provided with the lens antenna according to the present embodiment, it is possible to substantially completely block spillover by surrounding the periphery of the lens 11 with the substrate 1. Therefore, it is possible to approach the directivity the lens antenna itself.

In addition, for example, in the on-board radar provided with the lens antenna according to the present embodiment, since the electronic parts (the parts 21 to 39 in the present embodiment) and the like are present on the surface of the substrate 1 and the surface of the substrate 1 is uneven, the electromagnetic waves (the light from the primary radiators 51 to 53) are scattered and it is possible to reduce the intensity of unnecessary waves.

In addition, for example, in the on-board radar provided with the lens antenna according to the present embodiment, since the parts 21 to 39 can be implemented in the periphery of the lens 11 on the substrate 1, it is possible to reduce the overall volume in comparison to a case in which the parts are implemented on another portion, and it is possible to reduce the depth dimension (the dimension of the proceeding direction of the light from the primary radiators 51 to 53) of the radar. Furthermore, in the on-board radar, normally, the demand for reducing the depth dimension is greater than the demand for reducing the area (for example, the area of the surface which is parallel to the surface of the substrate 1) of the surface which is perpendicular to the depth.

In this manner, in the on-board radar provided with the lens antenna according to the present embodiment, it is possible to suppress spillover and to suppress the magnitude of the depth dimension.

In addition, as an example, it is preferable to apply the on-board radar provided with the lens antenna according to the present embodiment to a mid-range radar, however, the on-board radar may also be applied to various other radars.

Here, in the present embodiment, a single-sided circuit board is used as the substrate (the substrate 1 in the present embodiment), however, as other configuration examples a double-sided circuit board, a multilayer substrate, a build-up substrate or the like can also be used.

In addition, for example, when a double-sided circuit board, a multilayer substrate, a build-up substrate or the like is used, as the part implementation surface or the grounding surface, an arbitrary surface (this can be the surface of an inner layer) can be used for each. Furthermore, normally, even if there is a through hole, it is considered that the electromagnetic waves (the light) of spillover will not pass therethrough (at least, will not pass through to an extent that problems occur).

In addition, as the size, shape, material and the like of the substrate, various examples thereof can be used, respectively. For example, as the shape of the substrate, a substrate having a rectangular surface shape is used in the present embodiment, however, it is possible to use a square surface shaped substrate or a substrate of another shape as other configuration examples.

As an example, the first surface 101 and the second surface 102, which the substrate 1 has, do not have to be parallel to one another (may be nonparallel).

In addition, the parts which are electronic parts (the parts 21 to 39 in the present embodiment) and the like of the on-board radar according to the present embodiment, and are mounted on the substrate (the substrate 1 in the present embodiment) may be provided on an arbitrary surface (may be the surface of an inner layer) of the substrate, for example, the parts may be provided on two or more different surfaces.

As an example, when a substrate (for example, a double-sided circuit board or the like) is used where it is possible to implement the parts on both of a surface (equivalent to the first surface 101 of the substrate 1 in the present embodiment) which faces the primary radiators (the primary radiators 51 to 53 in the present embodiment) and a surface (equivalent to the second surface 102 of the substrate 1 in the present embodiment) of the opposite side of the substrate, of the two surfaces, the parts may be implemented on only one arbitrary surface, or the parts may be implemented on both surfaces. However, in a configuration in which the parts are provided on a surface which faces the primary radiators (the primary radiators 51 to 53 in the present embodiment) of the substrate, it is considered that the electromagnetic waves (the light) from the primary radiators are scattered by the parts on the substrate and the amount of the electromagnetic waves (the light) which returns to the primary radiators is reduced, and the configuration is therefore preferable.

In addition, for each of the parts, various components can be used.

In addition, for the disposition at which each of the parts is implemented on the substrate, various dispositions may be used, and as an example, random disposition can be used.

Furthermore, in relation to the configuration in which the parts (for example, the electronic parts) are implemented on the surface of the substrate which is disposed in the region in which the convex surface of the lens is disposed, while a problem of the method of implementation must be solved, this is considered to be a sufficiently feasible configuration in practice. In particular, in a configuration in which low profile parts are implemented, as in chip parts, IC (Integrated Circuit) elements and the like, it is considered that even if the parts are implemented on the surface of the substrate which is disposed on the region on which the convex surface of the lens is disposed, there is substantially no influence on the radiation of the light from the lens.

In addition, for the lens (the lens 11 in the present embodiment) which configures the lens antenna, various components can be used. For example, various shapes and sizes of lens can be used.

In addition, in the present embodiment a configuration was adopted in which the first surface 111 of the lens 11 is disposed so as to be positioned on the same surface as the first surface 101 of the substrate 1, and the second surface 112 of the lens 11 is disposed so as to protrude from the second surface 102 of the substrate 1. However, another disposition may also be used as the disposition of these components.

In addition, for the primary radiator which configures the lens antenna, various components can be used. For example, the number of primary radiators which configure the primary radiator unit 61 may be one, or may also be an arbitrary plurality. In addition, as the disposition of the primary radiators, various dispositions can be used.

FIG. 6 is a view showing a configuration example of a primary radiator unit 81 provided with five primary radiators 71 to 75. In this configuration example, the positions of the five primary radiators 71 to 75 are displaced so as to be positioned at an equal interval (or a substantially equal interval) on an arc (or a shape such as a polygonal shape close to an arc).

In addition, in the present embodiment, the three primary radiators 51 to 53 and the substrate 1 are disposed (hereinafter referred to as the first disposition example) such that the direction in which the three primary radiators 51 to 53 are arranged and the extending direction of the short sides of the rectangle which defines the substrate 1 substantially match (as another configuration example, when the three primary radiators 51 to 53 are arranged in a straight line, the direction in which the primary radiators 51 to 53 are arranged and the extending direction of the short sides of the rectangle which defines the substrate 1 match). However, another configuration example may also be used.

As another configuration example, the three primary radiators 51 to 53 and the substrate 1 may also be disposed (hereinafter referred to as the second disposition example) such that the direction in which the three primary radiators 51 to 53 are arranged and the extending direction of the long sides of the rectangle which defines the substrate 1 substantially match (as another configuration example, when the three primary radiators 51 to 53 are arranged in a straight line, the direction in which the primary radiators 51 to 53 are arranged and the extending direction of the short sides of the rectangle which defines the substrate 1 match).

In regard to the first disposition example and the second disposition, description will be given of the general differences in the electrical design in relation to the beam width (the radiation angle of the beam) of the primary radiator.

In other words, the first disposition example is a case in which the beam width in the vertical direction is set to be narrower than the beam width in the horizontal direction, and since an elliptical lens is used which has a vertical long axis, it is preferable that the substrate also be a vertically-long rectangle or ellipse.

On the other hand, the second disposition example is a case in which the beam width in the vertical direction is set to be wider than the beam width in the horizontal direction, and since an elliptical lens is used which has a vertical short axis, it is preferable that the substrate also be a vertically-short rectangle or ellipse.

Furthermore, when the beam width in the horizontal direction and the beam width in the vertical direction are the same (or similar), a lens is used which is a perfect circle or a substantially perfect circle, and it is preferable to use a square substrate.

Here, in the present embodiment, as the disposition of a general primary radiator in the multi-focus lens antenna, as shown in FIG. 6, for example, a configuration is used in which a plurality of the primary radiators are disposed nonlinearly.

As another configuration example, it is also possible to use a disposition in which the plurality of primary radiators are arranged at an equal interval (or a substantially equal interval) in series on a straight line. In this case, normally, it is necessary to provide an array of the primary radiators, add a waveguide element or adapt the lens.

Furthermore, in a configuration in which there is a plurality of the primary radiators and the neighboring primary radiators are disposed close to one another, the area for narrowing the electromagnetic wave (the light) is reduced and the influence of spillover is increased. Therefore, in such a multi-beam configuration, in particular, it is considered that the effect (the effect of the reduction in the influence of spillover) of the on-board radar provided with the lens antenna according to the present embodiment is exhibited.

In addition, various dispositions may be used as the overall disposition of the substrate portion and the primary radiator unit 61 which configure the on-board radar according to the present embodiment.

In addition, various components may be used as a part (not shown) such as a cover (a housing) other than the substrate portion and the primary radiator unit 61 which configure the on-board radar according to the present embodiment. In addition, as the disposition thereof, various dispositions can be used.

### Modification Example

Other configuration examples are shown in relation to the disposition of the primary radiator and spillover countermeasure which are anticipated.

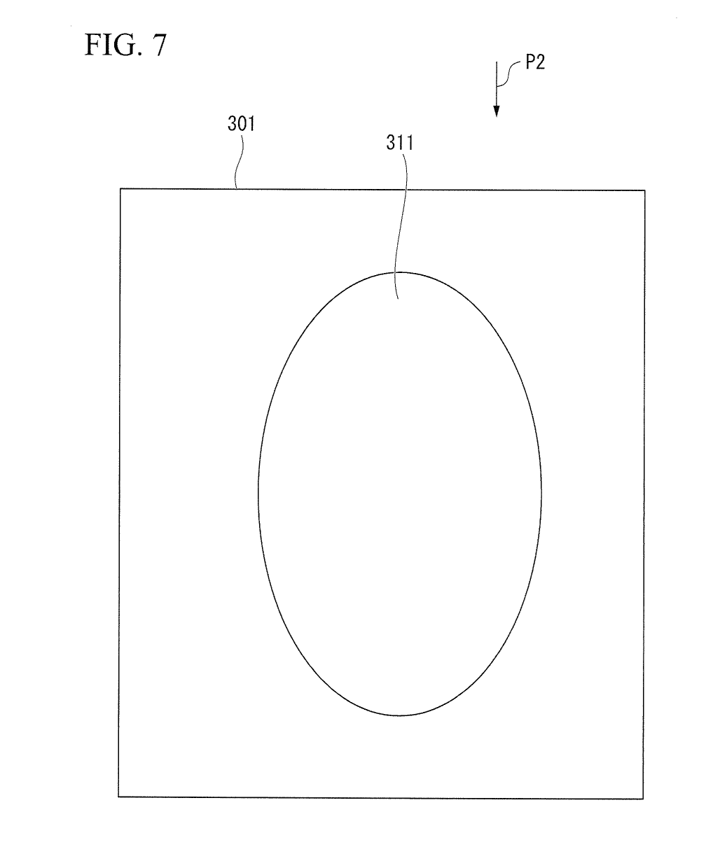

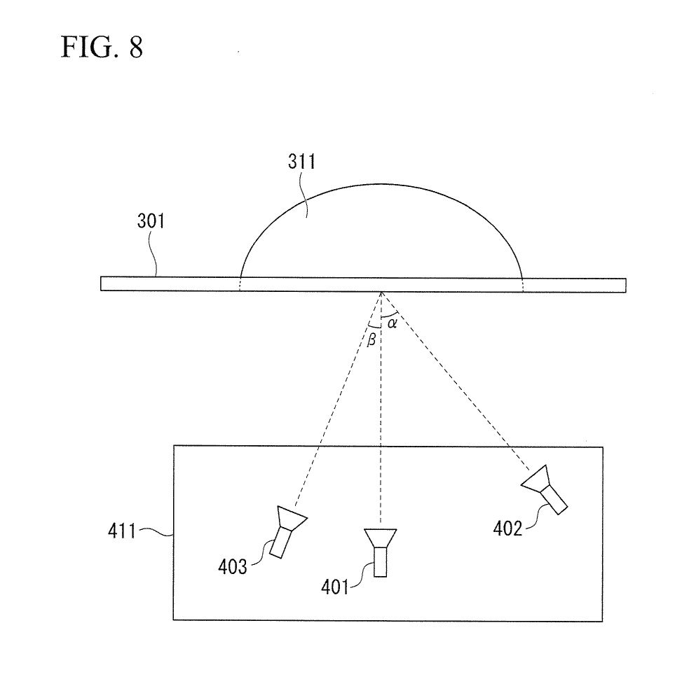

Description will be given of the configuration example of a case in which the beam center axis lines of primary radiators 401 to 403 are non-symmetrically disposed with reference to FIGS. 7 and 8.

Furthermore, the schematic configuration of the entire on-board radar shown in FIGS. 7 and 8 is the same as the schematic configuration of the entire on-board radar shown in FIGS. 1 and 2. However, as described below, the configuration in FIGS. 7 and 8 is different in that the beam center axis lines of the primary radiators 401 to 403 are non-symmetrically disposed.

FIG. 7 is a schematic rear surface view (a view when seen from the disposition region of the primary radiators 401 to 403) of the substrate portion which configures the on-board radar provided with the lens antenna in which the beam center axis lines of the primary radiators 401 to 403 are non-symmetrically disposed.

FIG. 8 is a schematic upper surface view (a view when seen from the orientation of an arrow P2 shown in FIG. 7) of the substrate portion and a primary radiator unit 411 (which contains the three primary radiators 401 to 403) which configure the on-board radar provided with a lens antenna in which the beam center axis lines of the primary radiators 401 to 403 are non-symmetrically disposed.

Here, in FIG. 7, a substrate 301 and a lens 311 are shown. Furthermore, in FIG. 7, the primary radiator unit 411 (which contains the three primary radiators 401 to 403) and parts (which are the same as or similar to the parts 21 to 39 shown in FIG. 1) are omitted from the drawing.

In addition, in FIG. 8, the substrate 301, the lens 311 and the primary radiator unit 411 (which contains the three primary radiators 401 to 403) are shown. Furthermore, in FIG. 8, the parts are omitted from the drawing.

In the configuration shown in FIGS. 7 and 8, the plurality of focal points of the lens 311 are determined by the design method of the lens 311. The plurality of focal points are not necessarily limited to being disposed on an arc. In addition, as shown in FIG. 8, when the primary radiators are non-symmetrically disposed, the plurality of primary radiators (the three primary radiators 401 to 403 in the present embodiment) are not arranged at an equal interval.

In the configuration example shown in FIG. 8, there is an angle α between the beam center axis line (in the example of FIG. 8, the line extends perpendicular to the surface of the lens 311 and matches the light axis of the lens 311) of the central primary radiator 401 and the beam center axis line of the primary radiator 402, which is one of the neighboring primary radiators. In addition, there is an angle β between the beam center axis line of the primary radiator 401 and the beam center axis line of the primary radiator 403, which is the other neighboring primary radiator. Furthermore, the angle β is set to be smaller than the angle α (α>β).

It is possible to adopt the following configuration as a spillover countermeasure in the disposition of the primary radiators 401 to 403.

In other words, the more acute the angle of the beam center axis line of the primary radiator in relation to the optical axis of the lens 311, the more intense spillover is. Therefore, as shown in FIGS. 7 and 8, it is preferable to adopt a configuration in which the size (the area) of the region of a substrate 301 close to the primary radiator (the primary radiator 403 in the present configuration example) in which the beam center axis line is disposed at an acute angle in relation to the optical axis of the lens 311 is larger than the other regions of the substrate 301.

As described above, in the present configuration example, by increasing the size of the region of the substrate 301 which is close to the primary radiator (the primary radiator 403 in the present configuration example), the beam center axis line of which is disposed at an acute angle in relation to the optical axis of the lens 311, so as to be greater than the size of the other regions of the substrate 301, it is possible to reduce the influence of spillover.

Furthermore, the plurality of parts may be arbitrarily implemented on the substrate 301, for example, more parts can be implemented in the region of the substrate 301 which has a large size than the parts which are disposed on the region of the substrate 301 which has a small size. In this case, it is possible to set the ratio of the size of each of the regions (for example, the left side region and the right side region, or the upper side region and the lower side region) of the substrate 301 and the ratio of the number of parts which are implemented on each region to be matching values or similar values.

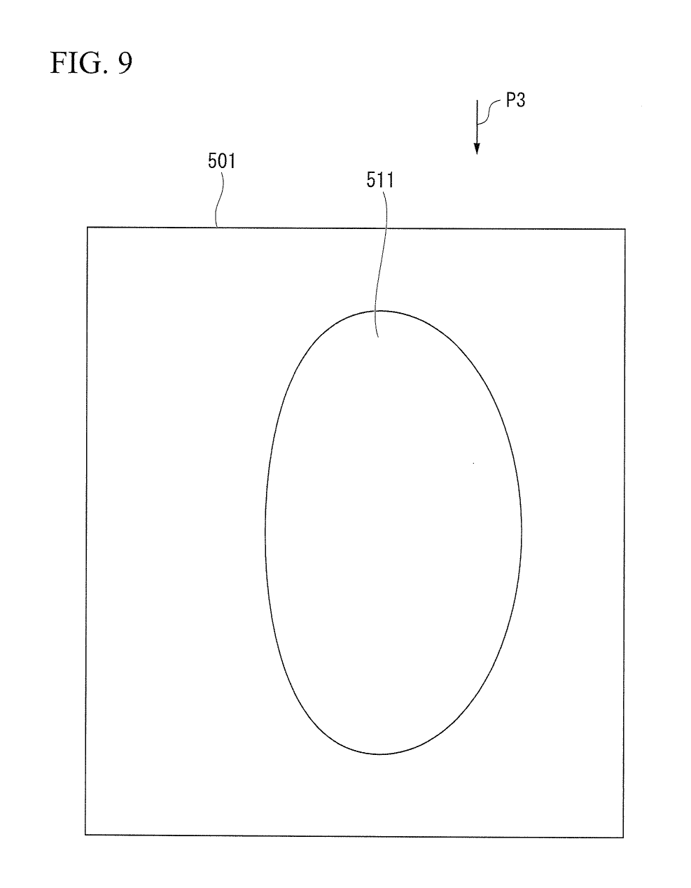

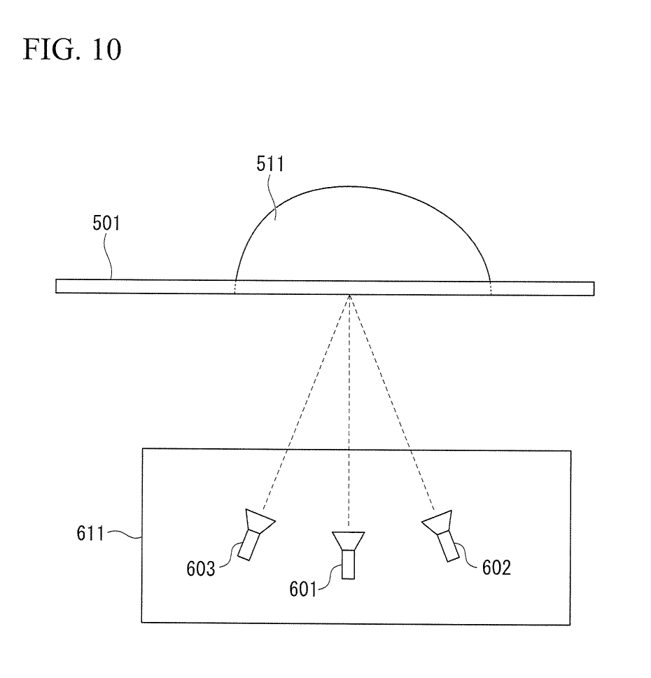

Next, description will be given of the configuration example of a case in which the beam widths of primary radiators 601 to 603 are different from one another with reference to FIGS. 9 and 10.

Furthermore, the schematic configuration of the entire on-board radar shown in FIGS. 9 and 10 is the same as the schematic configuration of the entire on-board radar shown in FIGS. 1 and 2. However, as described below, the configuration in FIGS. 9 and 10 is different in that the beam widths of the primary radiators 601 to 603 are different from one another.

FIG. 9 is a schematic rear surface view (a view when seen from the disposition region of the primary radiators 601 to 603) of the substrate portion which configures the on-board radar provided with the lens antenna of a configuration in which the beam widths of the primary radiators 601 to 603 are different from one another.

FIG. 10 is a schematic upper surface view (a view when seen from the orientation of an arrow P3 shown in FIG. 9) of the substrate portion and a primary radiator unit 611 (which contains the three primary radiators 601 to 603) which configure the on-board radar provided with a lens antenna of a configuration in which the beam widths of the primary radiators 601 to 603 are different from one another.

Here, in FIG. 9, a substrate 501 and a lens 511 are shown. Furthermore, in FIG. 9, the primary radiator unit 611 (which contains the three primary radiators 601 to 603) and parts (which are the same as or similar to the parts 21 to 39 shown in FIG. 1) are omitted from the drawing.

In addition, in FIG. 10, the substrate 501, the lens 511 and the primary radiator unit 611 (which contains the three primary radiators 601 to 603) are shown. Furthermore, in FIG. 10, the parts are omitted from the drawing.

In the configurations shown in FIGS. 9 and 10, the shape of the lens 511 changes the aperture length according to the degree that the width of the beams radiated from the primary radiators 601 to 603 are narrowed. As shown in FIGS. 9 and 10, in the present configuration example, in relation to the shape of the lens 511, the aperture length of the portion close to the primary radiator (the primary radiator 603 in the present configuration example) having a wide beam width is shorter than the aperture length of the portion close to the primary radiator (the primary radiator 602 in the present configuration example) having a narrow beam width.

In the configuration shown in FIGS. 9 and 10, the plurality of focal points of the lens 511 are determined by the design method of the lens 511. The plurality of focal points are not necessarily limited to being disposed on an arc. When the primary radiators are non-symmetrically disposed, the plurality of primary radiators (the three primary radiators 601 to 603 in the present embodiment) are not arranged at an equal interval.

It is possible to adopt the following configuration as a spillover countermeasure in the disposition of the primary radiators 601 to 603.

In other words, a region close to a primary radiator in which there is little beam narrowing (a region close to the primary radiator in which the beam width is wide) is greatly influenced by spillover. Therefore, as shown in FIGS. 9 and 10, it is preferable to adopt a configuration in which the size (area) of the region of the substrate 501 close to the portion of the lens 511 which has a short radius is larger than the other regions of the substrate 501.

As described above, in the present configuration example, by increasing the size of the region of the substrate 501 which is close to the primary radiator which has a greater beam width so as to be greater than the size of the other regions of the substrate 501, it is possible to reduce the influence of spillover.

Furthermore, the plurality of parts may be arbitrarily implemented on the substrate 501, for example, more parts can be implemented in the region of the substrate 501 which has a large size than the parts which are disposed on the region of the substrate 501 which has a small size. In this case, it is possible to set the ratio of the size of each of the regions (for example, the left side region and the right side region, or the upper side region and the lower side region) of the substrate 501 and the ratio of the number of parts which are implemented on each region to be matching values or similar values.

### Configuration Example According to Present Embodiment

As a configuration example, there is provided an on-board radar having a lens antenna which includes the substrate 1 provided with the hole 5 for disposing the lens 11 which configures the lens antenna; the lens 11 which is disposed in the hole 5 which is provided in the substrate 1; a plurality of the parts 21 to 39 provided on a portion of the substrate 1 other than a portion on which the lens 11 is provided; and the primary radiators 51 to 53 which configure the lens antenna.

As a configuration example, it is preferable that the plurality of parts 21 to 39 be provided on a portion of the substrate 1 in the periphery of the lens 11.

As a configuration example, it is preferable that the plurality of parts 21 to 39 be provided on a surface of the substrate 1 which faces the primary radiators 51 to 53.

As a configuration example, it is preferable that the plurality of primary radiators 51 to 53 be provided as the primary radiators which configure the lens antenna.

Detailed description is given above of the embodiments of the invention with reference to the drawings. However, the specific configuration is not limited to the embodiments, and designs and the like which do not depart from the spirit of the invention are also included.

What is claimed is:

1. An on-board radar comprising:
a lens antenna which includes
a lens,
a substrate provided with a hole for disposing the lens,
a plurality of parts provided on a portion of the substrate other than a portion on which the lens is provided, and
a primary radiator which radiates electromagnetic waves onto the lens.

2. The on-board radar according to claim 1, wherein the plurality of parts is provided on a portion of the substrate in a periphery of the lens.

3. The on-board radar according to claim 1, wherein the plurality of parts is provided on a surface of the substrate which faces the primary radiator.

4. The on-board radar according to claim 1, wherein a plurality of primary radiators is provided as the primary radiator which configures the lens antenna.
